(19) United States
(12) Patent Application Publication
(10) Pub. No.: US 2017/0305083 A1
(43) Pub. Date: Oct. 26, 2017

(54) SYSTEMS AND METHODS FOR FORMING OPTICAL LENSES WITH AN UNDERCUT

(71) Applicants: David A Smith, Cary, NC (US); Patrick Goergen, Orlando, FL (US); Gunnar R. Wieboldt, Chapel Hill, NC (US)

(72) Inventors: David A Smith, Cary, NC (US); Patrick Goergen, Orlando, FL (US); Gunnar R. Wieboldt, Chapel Hill, NC (US)

(21) Appl. No.: 15/497,178

(22) Filed: Apr. 25, 2017

Related U.S. Application Data
(60) Provisional application No. 62/327,717, filed on Apr. 26, 2016.

(51) Int. Cl. B29D 11/00; G02B 3/08

(52) U.S. Cl. CPC B29D 11/00269; B29D 11/0048; G02B 3/08

(57) ABSTRACT

The present invention relates to systems and methods for forming a lens having a concave surface with at least one undercut. In one embodiment, the lens has a concave surface with at least one undercut. For example, a pliable lens with undercuts can be formed by using a pliable moldable material injected into a mold have a negative profile with at least one protrusion corresponding to an undercut of a target pliable lens. The pliable curved textured lens can now be peeled away from the mold after the shaped profile of the target pliable lens is set.

### CROSS-REFERENCE TO RELATED APPLICATION

This non-provisional application claims the benefit of co-pending U.S. provisional application No. 62/327,717 filed on Apr. 26, 2016, of the same title, which application is hereby fully incorporated in its entirety by this reference.

### BACKGROUND

The present invention relates to systems and methods for forming curved optical lens having a substantially concave surface with undercuts.

Quality textured lens, such as Fresnel lens, can be formed by casting and polishing. Casting processes generally involve introducing a liquefied material into an opposing pair of rigid molds. The lens are then allowed to solidify into a rigid shape using an appropriate step such as heating, cooling, or curing under ultraviolet light. As such, undercuts on the textured surface(s) are not permitted because they will severely impede the separation process needed to remove the rigid lenses from the rigid molds.

In some lens applications such as Fresnel lens, undercuts are desirable because they can substantially improve optical performance. It is therefore apparent that an urgent need exists for novel processes to form curved optical lens having a substantially concave surface with undercuts. These improved lenses with undercuts advantageously provide superior viewer experience by reducing the visibility of the undercut edges.

### SUMMARY

To achieve the foregoing and in accordance with the present invention, systems and methods for or forming curved optical lens having a substantially concave surface with one or more undercuts is provided.

In one embodiment, a pliable lens with undercuts is formed by using a pliable moldable material injected into a mold have a negative profile with at least one protrusion corresponding to at least one undercut of the target pliable lens. The pliable lens can now be peeled away from the mold after the shaped profile of the target pliable lens is set.

In this embodiment, the lens is a curved Fresnel lens with a plurality of concentric rings. These rings include a corresponding plurality of undercuts forming edges that are aligned to a user's eye to minimize visibility and optical noise.

In some embodiments, the concentric rings of the Fresnel lens are substituted by one or more spirals, so that the lens having the undercuts may be removed from a mold by a twisting motion in a manner similar to retracting a threaded screw.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is a cross-sectional view illustrating one embodiment of a pliable curved lens with undercuts, in accordance with the present invention;

FIGS. 2A and 2B illustrate the user's eye movements relative to the lens embodiment of FIG. 1;

FIGS. 3A and 3B depict an exemplary mold for shaping the lens embodiment of FIG. 1;

FIGS. 4 and 5 are inside back views illustrating two alternate embodiments of modified curved Fresnel lenses incorporated one or more spirals with undercuts, in accordance with the present invention;

FIG. 6 is an inside back view illustrating yet another embodiment of a textured curved lens with undercuts, in accordance with the present invention;

FIGS. 7A and 7B are cross-sectional views depicting profiling and reshaping processes for fabricating a curved lens with undercuts; and

FIG. 8 is a cross-sectional view illustrating an alternate embodiment of a supported mold for lens with undercuts, in accordance with the present invention.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “always,” “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

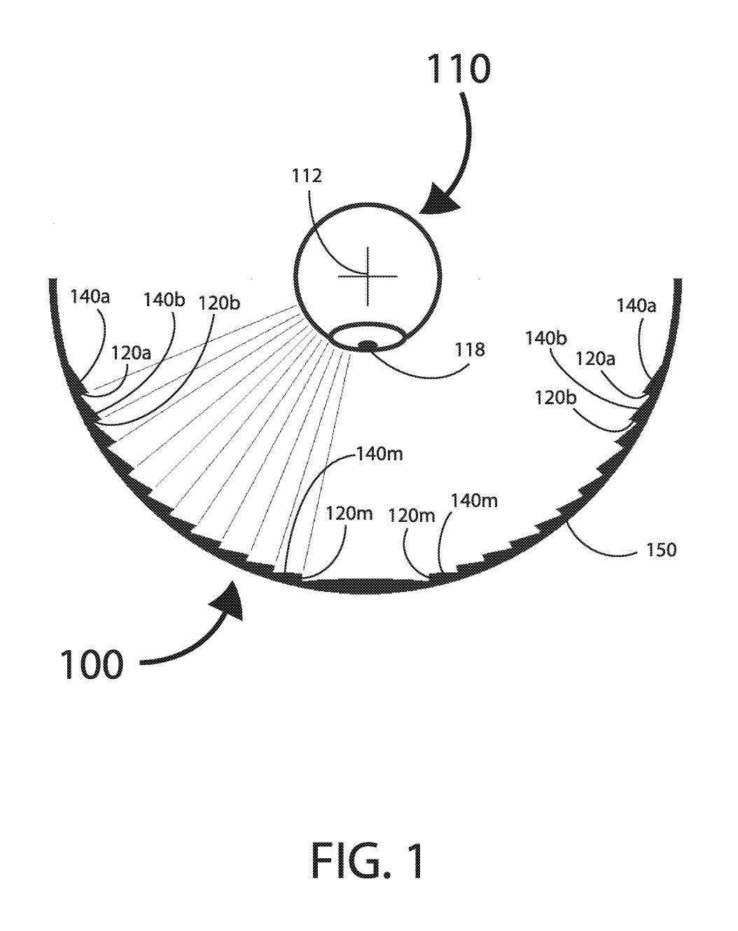

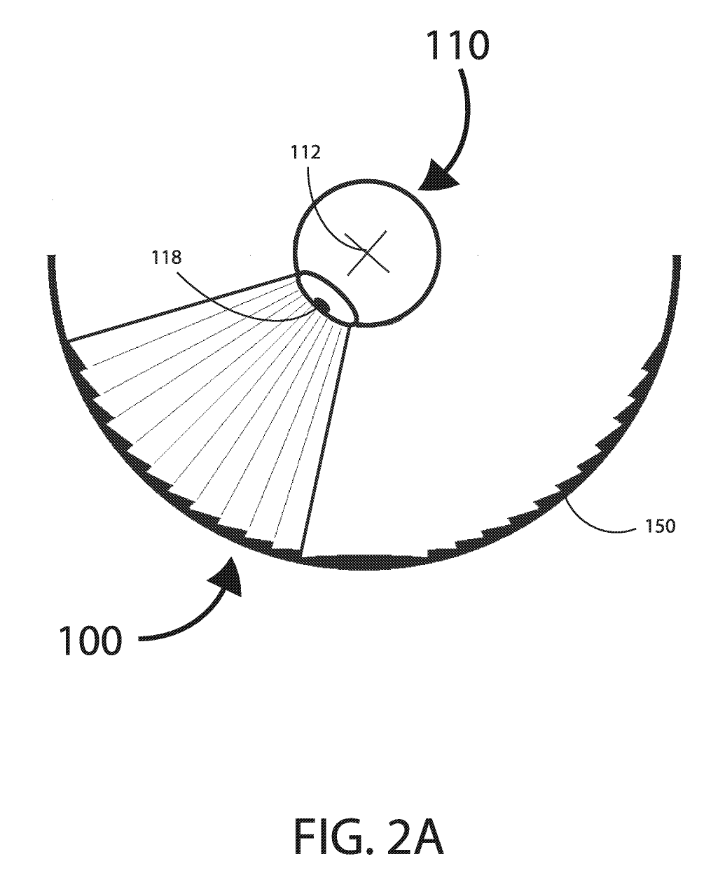

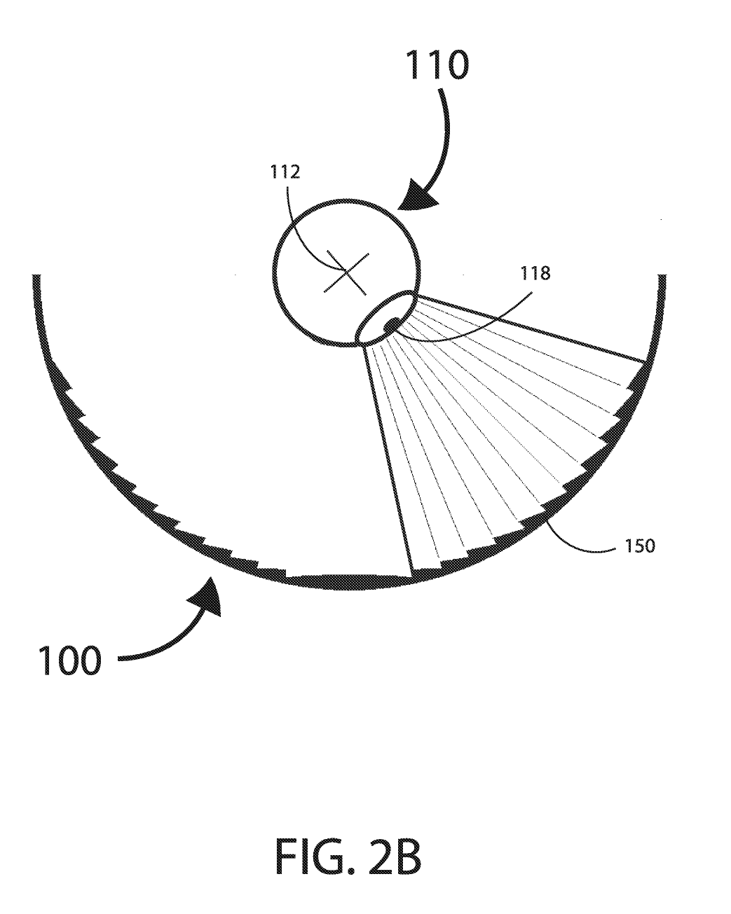

The present invention relates to systems and methods for forming lens with undercuts. To facilitate discussion, FIG. 1 illustrates a straight-ahead viewpoint, while FIGS. 2A-2B illustrate the field-of-view limits of a user's eye 110 relative to an exemplary textured lens 100 as eye 110 scans horizontally left-to-right and/or vertically up-to-down, and vice versa within the user's eye socket (not shown).

In accordance with the present invention, FIG. 1 depicts a cross-sectional view of an exemplary curved lens 100 in alignment with a user's eye 110. In this embodiment, lens 100 is a curved Fresnel lens and includes a plurality of draft facets 120a, 120b . . . 120m and a corresponding plurality of sloped facets 140a, 140b . . . 140m. The sloped facets 140a, 140b . . . 140m are configured to focus incoming light rays, originating from a source (not shown) located in front of convex surface 150, and directed toward the eye 110.

In order to improve the performance of Fresnel lens 100, the draft facets 120a, 120b . . . 120m are in substantial “line-of-sight” alignment with the user's eye 110. As such, these draft facets 120a, 120b . . . 120m appear to radiate outwards from within a focal plane and/or a focal point located on or in front of a retina of the user's eye 110.

Textured lens such as Fresnel lens can be formed by casting. Typical casting processes involve introducing a liquefied material into an opposing set of rigid mold halves. Consequently, rigid undercuts on the textured surface(s) are generally not permitted by casting processes because any lens undercuts are likely to impede the separation process necessary for removing a rigid lens from a rigid mold.

Referring again to FIG. 1, the introduction of outwardly “radiating” draft facets 120a, 120b . . . 120m on the inner surface of Fresnel lens 100 results in the presence of undercuts. Hence, in this embodiment of the present invention, a pliable material is used in place of a rigid lens material; thereby permitting the existence of optically-desirable undercuts, e.g., draft facets 120a, 120b . . . 120m.

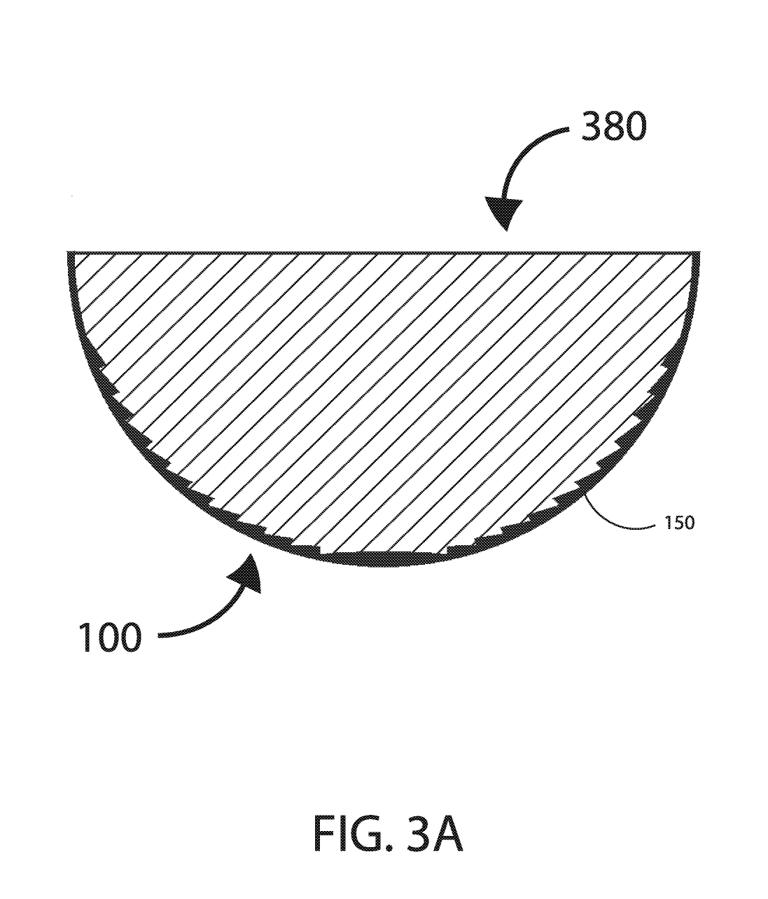

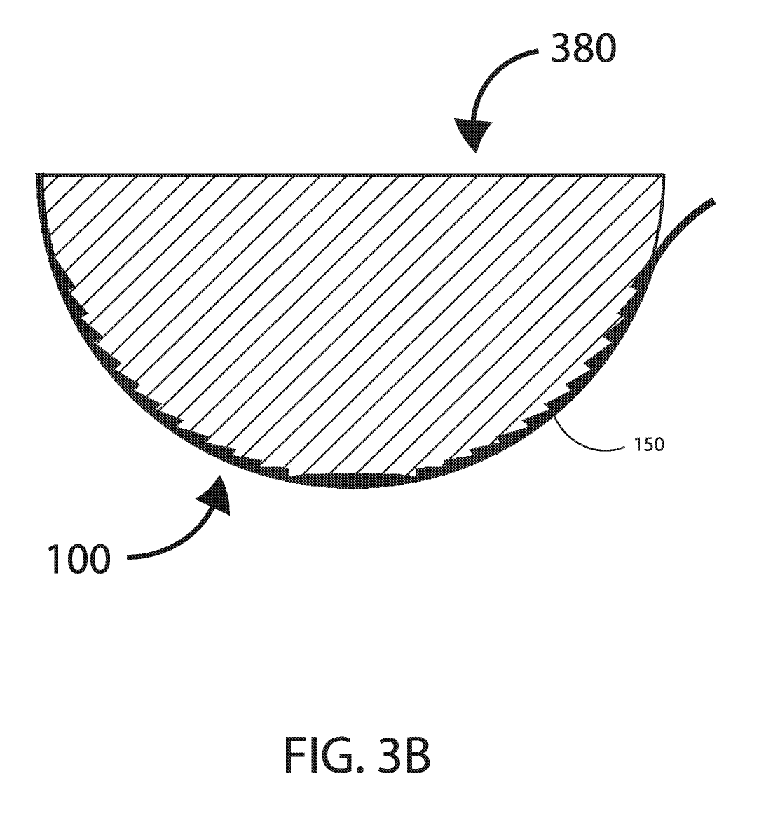

FIG. 3A illustrates the pliable lens 100 together with an inner mold 380 prior to peeling. FIG. 3B depicts pliable lens 100 while being the lens 100 is being peeled away from the inner mold 380. This novel lens structure is now possible because the resulting lens 100 remains pliable after lens formation and its flexible undercut(s) can be readily peeled away from inner mold 380 after the profile of lens 100 has been stabilized by mold 380 during lens formation.

In other words, the use of a pliable and removable lens material accommodates the rise of these Fresnel rings, as represented by draft facets 120a, 120b . . . 120m, on the inside of lens 100, configured to converge towards the eye 110. Consequently, draft facets 120a, 120b . . . 120m, are now invisible relative to the center of the eye 110. Instead, eye 110 only sees the operational lens surface, as represented by the corresponding plurality of sloped facets 140a, 140b . . . 140m. The resulting structure of lens 100 dramatically decreases various sources of “light pollution”.

Suitable materials for forming pliable, i.e., non-rigid, lens 100 include silicone compounds possessing refractive indexes similar to that of poly-methyl-methacrylate (PPMA) such as Acrylic 1.41, and Acrylic 1.48. Such pliable lenses are softer, more scratch resistant, more heat resistance and can be easily cleansed with alcohol.

In sum, the above described pliable lens formation processes advantageously provide superior viewer experience by minimizing interference rings generated by interior lens surface and visually removing ring edges, i.e., user viewpoints are aligned to the ring edges thereby minimizes visibility of the Fresnel ring edges.

Modifications and additions to the above systems and methods are contemplated within the scope of the present invention. For example, it may be possible to use a material that remains pliable through the molding process, and subsequent to removal from the mold, can be rendered substantially more rigid, “cured” or hardened using heat, ultra-violet light, ultrasound, an accelerant, a hardener and/or a catalyst. Other modifications to the above described pliable lens formation process may include the addition of an appropriate release agent prior to the introduction of the pliable lens material into the molds.

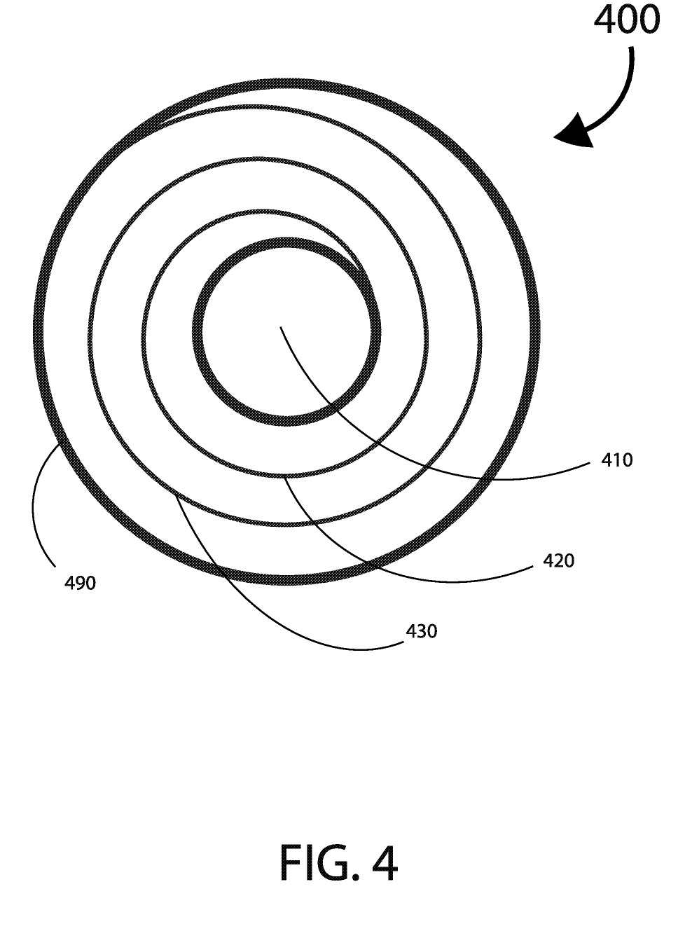

FIG. 4 is an inside back view illustrating a modified Fresnel textured curved lens 400 having at least one undercut, in accordance with another embodiment in accordance with the present invention. Curved lens 400 incorporating a spiral undercut 420-430, located between central lens 410 and an outer lens perimeter 490.

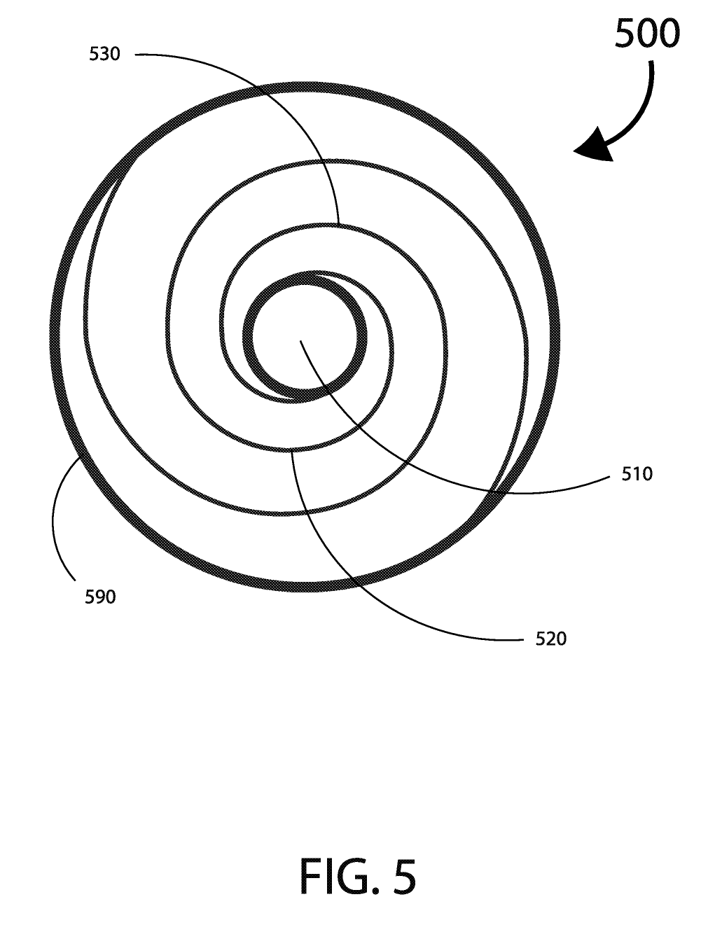

Referring now to FIG. 5, an inside back view depicting another exemplary embodiment of the present invention, a second modified Fresnel curved textured lens 500 includes a first spiral undercut 520 and a second spiral undercut 530, located between central lens 510 and an outer lens perimeter 590.

Accordingly, by selecting the appropriate spiral pitch profiles, modified Fresnel lenses with such spiral undercuts, e.g., curved lenses 400, 500 may now be rigid lens that can be removed from their respective molds by a simple twisting motion in a manner similar to the motion for retracting threaded screws.

Note that the coarse pitches of the respective spiral undercuts 410-420, 520 and 530 for curved lenses 400, 500 as shown in FIGS. 4 and 5 are merely exemplary. In some embodiments, the pitch of the spirals can be substantially finer thereby reducing the depths/heights of spiral undercuts while increasing the number of turns within each of the spirals. The resulting shallower spiral undercuts are rendered less visible to viewers thereby substantially improving resolution and subsequently viewer experiences.

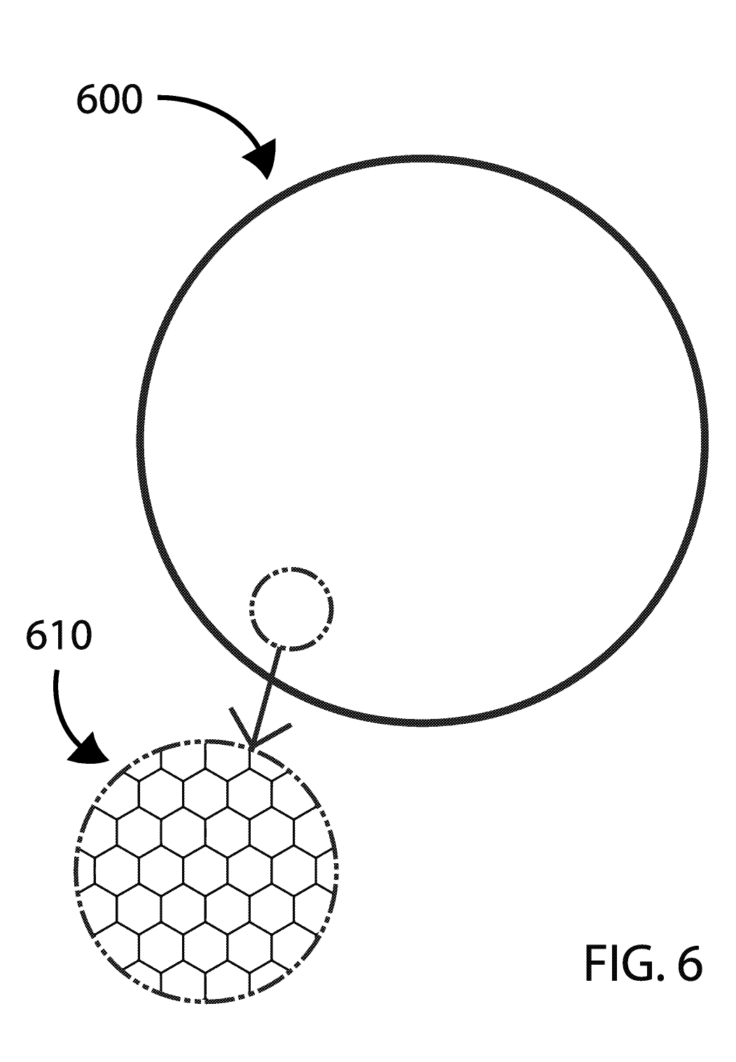

In addition, it may also be possible to further minimize the lens edge appearances by, for example, replacing these concentric rings of lens 100 altogether, and substituting a tiled pattern with undercuts in place of a concentric ring pattern. Suitable tiled patterns include Penrose patterns and polygonal patterns such as rhomboids, and/or honeycombs, and combinations thereof, as exemplified by honeycomb curved lens 600 of FIG. 6. It may also be possible to tile lens with patterns that are partially or fully composed of miniature lenses (lenslets) having partially and/or fully curved profiles with undercuts.

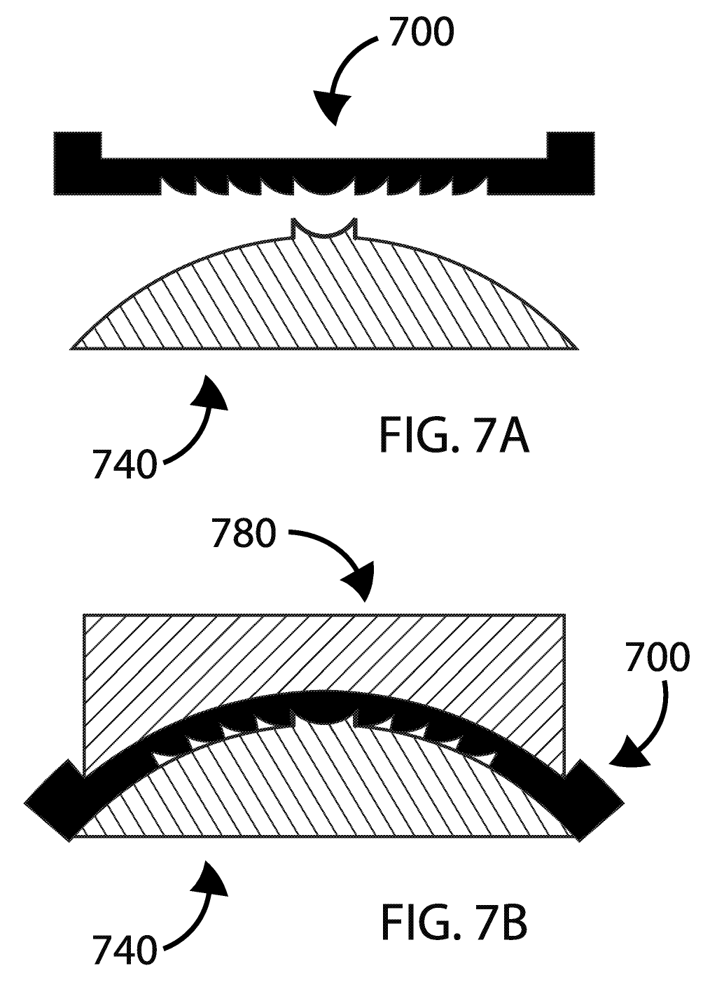

FIGS. 7A and 7B are cross sectional views depicting an exemplary process for fabricating a rigid curved lens 700 having at least one undercut, in accordance with another embodiment of the present invention. Fabrication of rigid curved lens 700 includes molding and reshaping.

Fabrication of lens 700 is made possible because thermoplastics can be weakened with increased temperature, yielding a viscous liquid that may be reshaped. Thermoplastics, or thermos-softening plastics, such as plastic polymers, become pliable or moldable above a specific temperature and solidifies upon cooling. Brittleness of thermoplastics may be decreased with the addition of plasticizers. Accordingly, suitable materials for fabricating lens 700 include thermoplastics, e.g., amorphous and semi-amorphous plastics with suitable refractive indexes and optical clarity.

In this embodiment as shown in FIG. 7A, exemplary lens 700 is first molded as a substantially flat rigid Fresnel lens without any undercuts. Once patterned with the Fresnel concentric rings, lens 700 is then aligned over the top of a curved bottom mold 740. Lens 700 is now reheated just enough to render it pliable without losing its lens pattern, e.g., the Fresnel concentric ring contours.

Referring now to FIG. 7B, a top mold 780 is then aligned to the top surface of lens 700. Pressure is then applied between the top mold 780 and the bottom mold 740 to reshape lens 700 to a desired curvature while maintaining the lens pattern. In this embodiment, lens 700 has been reshaped and stretched to form a three-dimensional bowl-like or saucer-like shape.

In some embodiments, depending on the desired final curvature, one or more intermediate molds with increasing curvature may be employed to minimize deformation of the lens pattern of lens 700. In other embodiments, a tiled pattern having, for example, polygons, may substitute the Fresnel lens pattern.

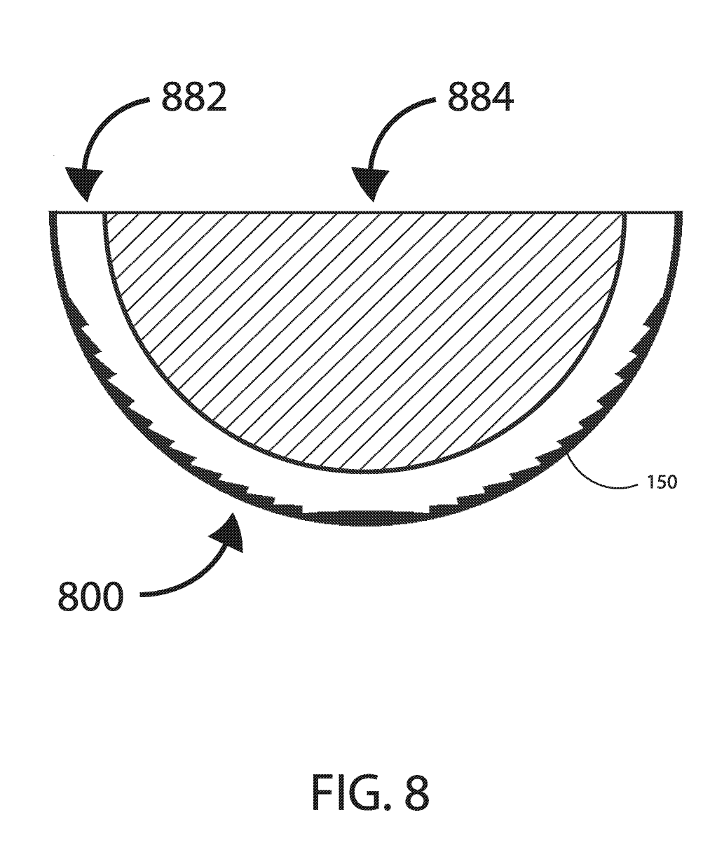

The novel fabrication principles of the present invention may also be applied to corollary processes for fabricating rigid lenses with undercuts. For example, as illustrated by FIG. 8, a two-part inner mold section includes a pliable top portion 882 with a textured negative pattern having a negative profile with at least one protrusion corresponding to one or more undercuts of the target curved textured lens 800. The pliable negatively-textured top portion 882 is supported by a rigid base portion 884, thereby maintaining a stable combined structure during lens formation. During lens release process, the base portion 884 is first separated from the pliable top portion 882, followed by the release of the lens 800 from the pliable top portion 882.

Alternatively, rigid lens with undercuts can also be manufactured using dissolvable or disintegrable molds such as wax molds. It may also be possible to form rigid lens with undercuts using additive manufacturing techniques such as 3-D printing.

While this invention has been described in terms of several embodiments, there are alterations, modifications, permutations, and substitute equivalents, which fall within the scope of this invention. It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A method for forming a lens having at least one undercut, the method comprising:
introducing a pliable moldable material into a mold having a negative profile including at least one protrusion corresponding to at least one undercut of a target lens pattern, thereby forming a pliable lens shaped according to the target lens pattern; and
peeling the pliable lens away from the mold after shaped profile of the pliable lens is set.

2. The method of claim 1 wherein the pliable lens is a curved lens.

3. The method of claim 2 wherein the curved lens is a Fresnel lens having a plurality of concentric rings which include the at least one undercut.

4. The method of claim 2 wherein the curved pliable lens is tiled with a grid pattern of lenslets which include the at least one undercut.

5. The method of claim 4 wherein the grid pattern includes a plurality of polygons.

6. The method of claim 1 wherein the pliable lens is a transparent lens.

7. The method of claim 1 further comprising hardening the pliable lens after removal from the mold.

8. The method of claim 1 further comprising introducing a release agent into the mold.

9. The method of claim 2 wherein the pliable lens is a curved modified Fresnel lens having at least one spiral which includes the at least one undercut.

10. The method of claim 4 wherein the grid pattern of the pliable lens includes a circular component.

11. A mold configured to form a pliable lens having at least one undercut, the mold comprising:
an outer portion configured to shape an upper surface of a pliable lens; and
an inner portion configured to shape a lower surface of the pliable lens, the inner portion having a negative profile that includes at least one protrusion corresponding to at least one undercut of the lower surface of the pliable lens.

12. The mold of claim 11 wherein the inner portion of the mold has a curved concave profile to shape the pliable lens.

13. The mold of claim 12 wherein the pliable lens is a curved Fresnel lens having a plurality of concentric rings which include the at least one undercut.

14. The mold of claim 12 wherein the curved pliable lens is tiled with a grid pattern of lenslets which include the at least one undercut.

15. The mold of claim 14 wherein the grid pattern includes a plurality of polygons.

16. The mold of claim 11 wherein the pliable lens is a transparent lens.

17. The mold of claim 12 wherein the pliable lens is a modified curved Fresnel lens having at least one spiral which includes the at least one undercut.

18. The mold of claim 14 wherein the grid pattern of the pliable lens includes a circular component.

19. A method for forming a lens having a curved surface with at least one undercut, the method comprising:
introducing a thermal-moldable material into a first mold having a negative profile including at least one protrusion corresponding to at least one target undercut of a target curved lens pattern, thereby forming a substantially flat lens with an initial flat lens pattern without any undercut; and
reshaping the initial flat lens into a curved lens using a curved mold wherein the initial flat lens pattern is morphed into a curved lens pattern with the at least one target undercut.

20. The method of claim 19 wherein the curved lens is a Fresnel lens having a plurality of concentric rings which include the at least one undercut.

21. The method of claim 19 wherein the curved lens is tiled with a grid pattern of lenslets which include the at least one undercut.

22. The method of claim 21 wherein the grid pattern includes a plurality of polygons.

23. The method of claim 19 wherein the curved lens is a transparent lens.

24. The method of claim 19 further comprising introducing a release agent into at least one of the first mold and the curved mold.

25. The method of claim 19 wherein the curved lens is a modified Fresnel lens having at least one spiral which includes the at least one undercut.
